(19) United States
(12) Patent Application Publication
(10) Pub. No.: US 2004/0230860 A1
(43) Pub. Date: Nov. 18, 2004

(54) Method and devices using path numbering in a fibre channel network

(75) Inventors: Shahe H. Krakirian, Palo Alto, CA (US); Kreg A. Martin, Los Gatos, CA (US)

Correspondence Address: WONG, CABELLO, LUTSCH, RUTHERFORD & BRUCCULERI,, P.C., 20333 SH 249, SUITE 600, HOUSTON, TX, 77070, US

(73) Assignee: Brocade Communications Systems, Inc.

(21) Appl. No.: 10/426,914

(22) Filed: Apr. 30, 2003

(51) Int. Cl. H02H 3/05

(52) U.S. Cl. 714/4

(57) ABSTRACT

A method for providing flexibility in configuring Fibre Channel devices for different mode of operation. The method uses Path Numbering mechanism to identify a flow path with a Fibre Channel device. The Path Number is used to associate source port and destination port to make the intermediate connection transparent for those two ports. Devices, switches, systems and networks implementing this method are also disclosed.

### CROSS-REFERENCE TO RELATED APPLICATIONS

This application is related to and incorporates by reference, U.S. patent application, Ser. No. 09/872,412, entitled “Link Trunking And Measuring Link Latency In Fibre Channel Fabric,” by David C. Banks, Kreg A. Martin, Shunja Yu, Jieming Zhu and Kevan K. Kwong, filed Jun. 1, 2000; Ser. No. 10/062,861 entitled “Methods and Devices for Converting Between Trunked and Single-Link Data Transmission in a Fibre Channel Network,” by Kreg A. Martin, filed Jan. 31, 2002 and Ser. No. 10/348,067 entitled “Cascade Credit Sharing For Fibre Channel Links” by Kreg A. Martin and Shahe Krakirian, filed Jul. 29, 2002.

### BACKGROUND OF INVENTION

The invention relates generally to data transmission in a Fibre Channel network and, more particularly but not by way of limitation, to techniques for providing flexibility in configuring Fibre Channel network devices.

As used herein, the phrase “Fibre Channel” refers to the Fibre Channel family of standards promulgated by the American National Standards Institute as ANSI X.3/T11. In general, Fibre Channel defines a high speed serial transport system that uses a hierarchically structured information exchange protocol consisting of frames, sequences and exchanges. A “frame” is the atomic unit of data transmission between two communicating devices. A “sequence” is a set of one or more related data frames transmitted unidirectionally from one device to another device within an exchange. An “exchange” is the basic construct for coordinating the transfer of information between communicating devices during higher layer protocol operations such as Small Computer System Interface (SCSI) and Transport Control Protocol/Internet Protocol (TCP/IP).

Referring to FIG. 1, communication between end devices such as server 100, storage unit 105, database server 110 and loop 115 (itself comprised of devices, not shown) is mediated by “fabric” 120, a term which refers to one or more operatively coupled Fibre Channel switches, e.g., 125, 130 and 135.

As described in the related applications, some Fibre Channel devices may have Fibre Channel ports at different speeds, some with high speed ports, some with low speed ports and some have different speed ports on the same device. They may be operated in modes for maximum (highest) speed or for maximum (longest) distance or at a compromise. They may be operated in various configurations for desired link characteristics. It is desirable to have methods and devices to make the configuration more flexible and efficient. It is desirable to have a method to configure the same hardware for many different applications.

### SUMMARY OF INVENTION

In present invention, the Path Numbering mechanism allows the simplified support of different modes of operation (e.g. 10G and long haul) and various configurations in each mode, using a single shared internal data path and the same hardware.

Using the Path Numbering mechanism, devices can be configured to operate in 10G mode for maximum transmission speed. For nodes and switches on the periphery of the “internal” switches which are using the PN mechanism, those “internal switches” are transparent, i.e. seemingly non-exist. The flow paths through the “internal switches” appear to be physically connected directly and have a dedicated connection. There is no “switching” necessary for a “dedicated” physical connection.

Using the Path Numbering mechanism, the same devices can be configured to operate in long haul mode for maximum transmission distance. These “internal switches” using the PN are similarly transparent. Many “internal switches” may be used in series to extend the connection distance which may be limited by a single physical link distance.

Using the Path Numbering mechanism, the devices can interconnect the existing Fibre Channel network with the newer high speed network.

### BRIEF DESCRIPTION OF THE DRAWINGS

FIG. 1 shows, in block diagram form, an illustrative prior art Fibre Channel network.

FIG. 2 shows an E-chip configured for 10G mode of operation.

FIG. 3 shows an internal frame format.

FIG. 4 shows an E-chip configured for 10G mode of operation using one Path Number, with all four GP ports trunked and the receiver buffer segregated into two segments.

FIG. 5 shows an E-chip configured for 10G mode of operation using four Path Numbers, with all four GP ports operating independently and the receiver buffer segregated into four segments.

FIG. 6 shows, in block diagram form, an E-chip configured for long haul mode of operation.

FIG. 7 shows, in block diagram form, an E-chip configured for long haul mode of operation using two Path Numbers, with two pairs of trunked GP ports.

FIG. 8 shows, in block diagram form, an E-chip configured for long haul mode of operation using four Path Numbers, with all GP ports operating untrunked.

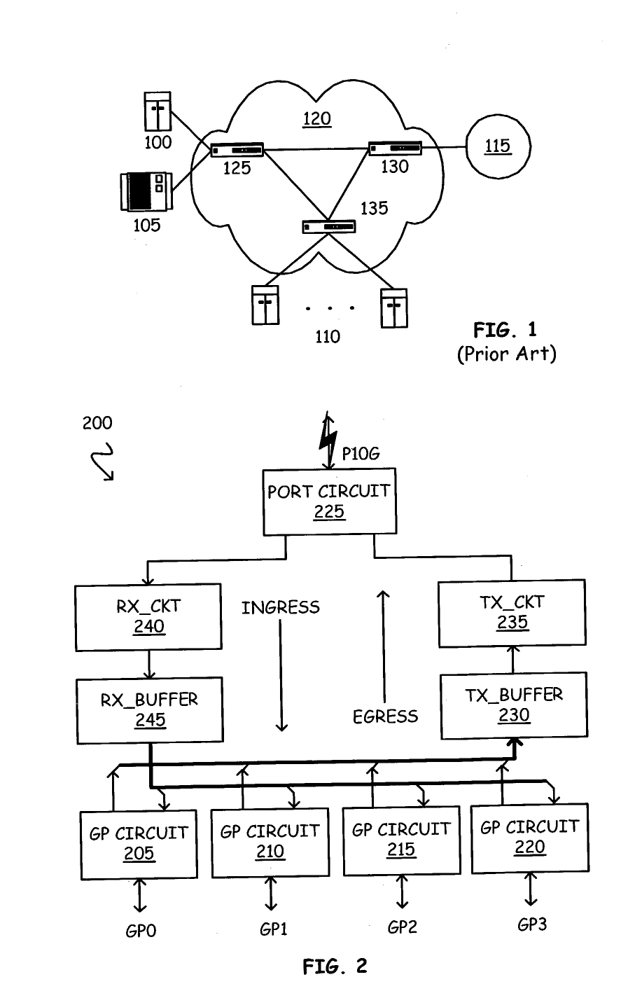

### DETAILED DESCRIPTION

The invention relates generally to data transmission and, more particularly but not by way of limitation, to methods and devices for providing flexibility in configuring Fibre Channel devices. The following embodiments of the invention, described in terms of a Fibre Channel network, are illustrative only and are not to be considered limiting in any respect.

FIG. 2 shows a high-level block diagram for a device 200, an E-chip in accordance with one embodiment of the invention, i.e. 10G mode of operation. As shown, device 200 may be communicatively coupled to a fabric (not shown) by up to four Fibre Channel gigabit port circuits 205, 210, 215 and 220 (identified as ports GP0 through GP3 or, collectively GP ports) and to one high-speed port circuit 225 (identified as port P10G). For example, GP ports 205 through 220 may each operate independently at 1, 2 or 3 gigabits per second (Gbps) and port P10G 225 may implement a four-lane 10 Gbps attachment unit interface (XAUI) circuit. Device 200 may manage the flow of frames in two directions: egress (from GP ports to port P10G) and ingress (from port P10G to GP ports).

In the egress direction, device 200 operates as a First In First Out device (FIFO) transmitting all frames received from GP ports 205, 210, 215 and 220 through transmit buffer TX_BUFFER 230 and transmit circuit TX_CKT 235 to port P10G 225 in exactly the same order as they are received at the GP ports. In this mode of operation, device 200 does not prioritize frame traffic based on virtual channel identifier (VC_ID) or path number (PN). Path Number (PN) is used by the Path Numbering mechanism of the present invention to facilitate the Fibre Channel device configuration for different operations. The various uses of PN will be described throughout the Detailed Description. In the particular embodiment shown in FIG. 2, the PN of an egress frame is assigned by TX_BUFFER 230 based on the source GP and passed through TX_CKT 235 to port P10G 225. As used here in a 10G mode of operation, a PN identifies a bi-directional data flow path through device 200 and VC identifies a specific virtual (i.e., logical) circuit within a stream of frames associated with a single PN. A data flow path is a path between a source and a destination, where frames flow from the source to the destination. A data flow path may be bidirectional, i.e. frames can flow in both directions, from a source to a destination and from the destination (a new source) to the source (a new destination). A data flow path may also be unidirectional, i.e., frames can only flow in one direction, from a source to a destination. The reverse flow direction, i.e., frames flowing from the destination (a new source) to the source (a new destination), is a new flow path.

In the ingress direction, RX_BUFFER 245 stores every frame received by port P10G 225 (through RX_CKT circuit 240) in one of up to four segments, mapping each segment to one or more destination GP ports. Specifically, frames can be mapped to the one or more segments within RX_BUFFER 245 based on VC and PN identifiers. Thus, because frames are routed to RX_BUFFER 245 segments based on VC and PN and further because frames are transmitted out of each segment in the order in which they are received therein (that is, each segment may be organized as a FIFO), frame ordering within VC and PN can be maintained.

In one embodiment, port P10G 225 and each GP port (205, 210, 215 or 220) may be independently configured to operate as an E-Port (a label used to identify a switch-to-switch, or intra-fabric, port), F-Port (a label used to identify a fabric port coupled to a single device such as a server, workstation, database or storage unit) or N-port (a label used to identify a fabric port on a node, such as a server or a workstation etc..). Each port circuit, therefore, may independently utilize Fibre Channel ARB primitives before transmitting a data frame to identify the relevant virtual channel; as described in Ser. No. 09/929,627 entitled “Quality of Service Using Virtual Channel Translation” by David C. Banks and Alex Wang, filed Aug. 13, 2001, which is hereby incorporated by reference; and VC_RDY primitives for flow control to indicate if the particular virtual channel can receive or transmit data packets. In one particular embodiment, F-Ports operate with a single VC identifier (e.g., VC_ID=0) while E-Ports support up to 12 virtual channels (VC_ID=0 to 11). In addition, port P10G 225's ARB and VC_RDY messages may have an associated Path Number (PN) and Virtual Channel (VC), while each GP port 205, 210, 215 and 220 may have associated only with VCs.

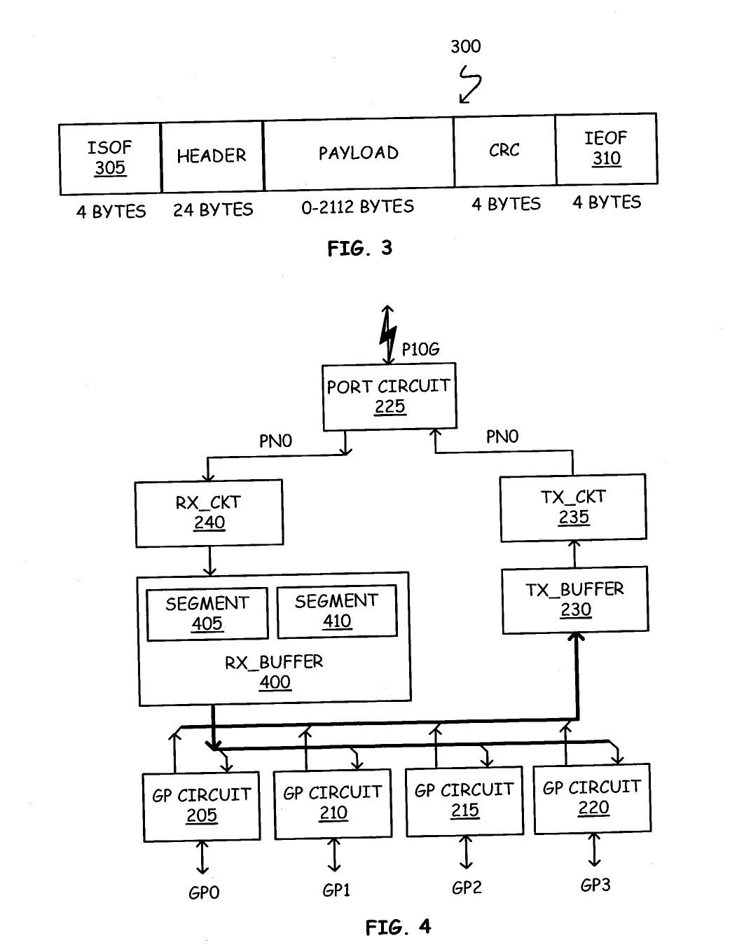

Frames passing though device 200 may be formatted in accordance with FIG. 3 and routed using Fibre Channel ARB and VC_RDY primitives. In one embodiment, device 200's internal frame format 300 is the same as the standard Fibre Channel frame format except for its start of frame (ISOF field 305) and end of frame (IEOF field 310) fields. Table 1 defines ISOF field 305 and Table 2 defines IEOF field 310. Tables 3 through 5 illustrate the Fibre Channel ARB and VC_RDY primitives as used in the preferred embodiment in E-Port mode. The ARB and VC_RDY primitives are not defined by the ANSI standards for E-Port mode use, but are used in the preferred embodiment in that mode for the operations described herein.

TABLE 1
Illustrative ISOF Field Definition

| Bits | Function |
|---|---|
| 31:28 | The one's complement of bits 27:24. This value is checked before |
| | a frame is transmitted out of device 200 and the frame is |
| | invalidated if there is a mismatch. |
| 27:24 | Encodes the Fibre Channel start of frame (SOF) type. |
| 23:0 | Reserved. |

TABLE 2
Illustrative IEOF Field Definition

| Bits | Function |
|---|---|
| 31:30 | Frame error code: NO_ERR if no error is detected; INV_FRM to |
| | signify an invalid frame because, for example, of a frame CRC |
| | error, EOF type mismatch RX_BUFFER 245 timeout; and |
| | ABRT_FRM to signify an abort frame error because, for example, |
| | the frame size is less than 36 bytes or greater than 2148 bytes or |
| | because of a device 200 internal data path parity error. |
| 29:27 | The one's complement of bits 26:24. This value is checked before |
| | a frame is transmitted out of device 200 and the frame is |
| | invalidated if there is a mismatch. |
| 26:24 | Encodes the Fibre Channel end of frame (EOF) type. |
| 23:22 | Reserved. |
| 21:20 | Path Number (PN) which generally equates to Source Fibre |
| | Channel port (GP0-GP3) identifier. When a frame is received by |
| | one of GP ports 205-220, this field identifies the port. When a |
| | frame is received by port P10G 225 in the trunked mode, this field |
| | is forced to ‘00b.’ When a frame is received by port P10G |
| | 225 in the non-trunked mode, this field identifies which port |
| | in the externally transmitting device sent the frame. |
| 19:16 | Virtual channel identifier. |
| 15:0 | Encodes the sequence number associated with the frame. The |
| | sequence number is used by RX_BUFFER 245 to ensure that |
| | frames associated with a given source port and virtual channel are |
| | transmitted in the same order as they are received. For each source |
| | port and virtual channel, this field can be incremented by one for |
| | each frame received by RX_BUFFER 245. Other functional |
| | blocks within device 200 may ignore this field. |

TABLE 3
ARB and VC_RDY primitives Transmitted/Received
by Ports GP0-GP3 in E-Port Mode

| | |
|---|---|
| Primitive | Format |

| | | | | |
|---|---|---|---|---|
| ARB | K28.5 | D20.4 | VC_ID | VC_ID |
| VC_RDY | K28.5 | D21.7 | VC_ID | VC_ID |

TABLE 4
ARB and VC_RDY primitives Transmitted/Received
by Port P10G in E-Port Mode

| | |
|---|---|
| Primitive | Format |

| | | | | |
|---|---|---|---|---|
| ARB | K28.2 | D20.4 | PN_VC | PN_VC |
| VC_RDY | K28.2 | D21.7 | PN_VC | PN_VC |

Where the PN_VC format can be an 8-bit field defined as shown in Table 5.

TABLE 5
PN_VC Field Format

| Bits | Function |
|---|---|
| 7:6 | Path number. |
| 5:4 | Reserved. |
| 3:0 | Virtual channel identifier. |

For the particular embodiment of FIG. 2, Table 6 shows typical clock speeds and throughput rates for each GP port 205-220 and port P10G 225. (Each of GP0-GP3 may have its clock speed set independent of the other ports.)

TABLE 6
Supported Data Rates for the Embodiment of FIG. 2

| | | Data Rate | |
|---|---|---|---|
| Fibre Channel | Fibre Channel Port | Per GP | Combined GP Port |
| Port Type | Clock (MHz) | Port (Gbps) | Data Rate (Gbps) |
| 1 Gigabit | 53.125 | 0.85 | 3.4 |
| 2 Gigabit | 106.25 | 1.7 | 6.8 |
| 3 Gigabit | 159.375 | 2.55 | 10.2 |

Referring to FIG. 4, device 200 may be configured such that all four GP ports 205, 210, 215 and 220 are trunked and port P10G 225 is coupled to a 10 Gbps XAUI compatible device. In this configuration, there is only one bidirectional frame flow path, an egress flow path from four-trunked GP ports to one P10G port and an ingress flow path from P10G port to four trunked GP ports. The four-trunked GP ports may be viewed as a single logical port and the corresponding P10G port may be viewed as another single logical port. A logical port is a port where frames are received and transmitted. A logical port may be a single physical port, a group of trunked ports, e.g. the four trunked GP ports here, or a part of a physical port, as will be described later, when four logical ports share a single P10G port. Each GP port (i.e. GP port 205, 210, 215 and 220) may be configured independently. For ease of operation, they are usually configured identically. Only one PN is needed and assigned to this single flow path. To internal devices (i.e. devices connected to the GP ports) and external devices (i.e. devices connected to the P10G port), there is only one transparent link between them. Typically, internal devices are closeby while external devices are far-away from the device 200. Accordingly, all ports (GP0-GP3 and P10G) are configured as E-Ports and the memory associated with RX_BUFFER 400, which may be implemented as one physical memory space, may be partitioned into two segments:

1. A relatively large segment 405 (configured as a FIFO) for ingress frames belonging to a specified virtual channel. Frame data is throttled into segment 405 in accordance with Fibre Channel “credit” flow control mechanisms. Preferably the large segment 405 is the remainder of the RX_BUFFER 400 after providing space for a small segment 410 described next. Receive buffers for the specified virtual channel are allocated in segment 405 and advertised to the external transmitting device. (Additional receive buffers residing in a device(s) coupled to one or more of GP ports 205, 210, 215 and 220 may also be advertised to the external transmitting device.)

2. A relatively small segment 410 (configured as a FIFO) that has only a small number of any allocated receive buffers but does not advertise or indicate any credits associated with those buffers. Segment 410 may be used for ingress frames belonging to all other virtual channels. The amount of the RX_BUFFER 400 reserved for the small segment 410 is based on the number of credits for the GP ports 205, 210, 215 and 220, the frame rates of the GP Ports 205, 210, 215 and 220 and the P10G port 225, the number of frames temporarily buffered, the number of RDYs sent and other relevant factors. In most cases the size is less than 100k bytes.

As a general rule, at least one segment is assigned to each PN. When a PN has multiple VCs, multiple segments may be assigned to the PN or the VCs may share the same segment. It is also possible and desirable in some situations that some VCs share one segment while other VCs each have its own segment.

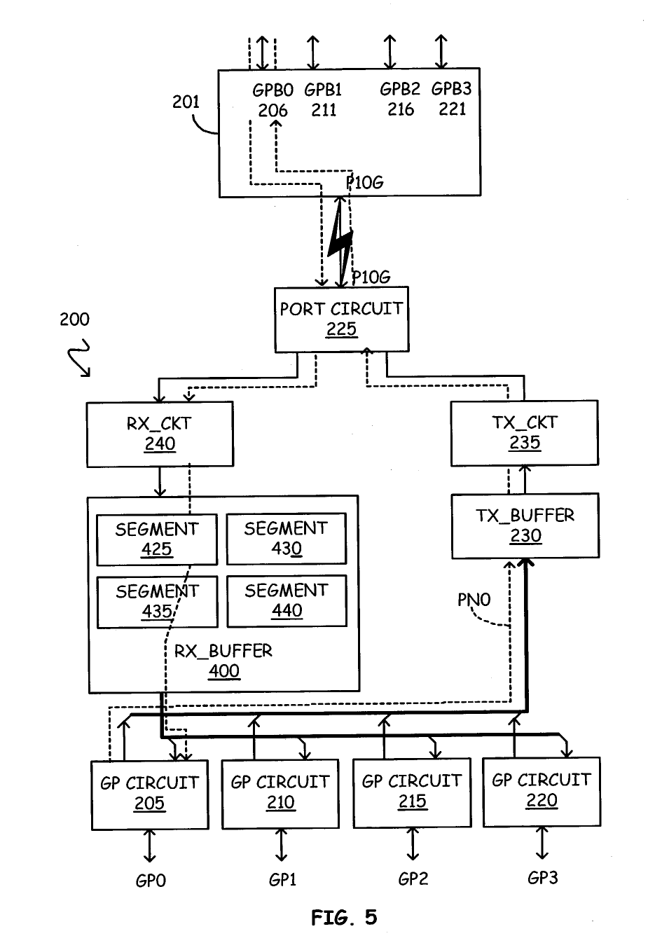

Referring to FIG. 5, device 200 may be configured to operate in 10G mode, but with all GP ports 205, 210, 215 and 220 operating independently, i.e. untrunked. The P10G port on device 200 is connected to another P10G port on device 201 through a long distance link. The device 201 is identical to device 200. The internal details of device

are not shown in FIG. 5. There are four bidirectional flow paths between the GP ports and the P10G port. Between each GP port and the P10G port, there is an independent flow path. In this case, four PNs are necessary, one for each flow path, i.e. one for each GP port. A unique PN identifies a flow path, the source GP port and the destination GP port. Here, each GP port may be viewed as a single logical port while the P10G port is shared by four logical ports. The P10G port is configured as an E-port so that the PN information is transferred over the 10G link with the ARB and VC_RDY primitives. An egress frame received by E-chip 200 from a given GP port is passed through device 200 and transmitted over the 10G link with its PN value. An ingress frame received by the P10G port is passed though the ASIC with its PN and transmitted by the associated GP.

When device 200 using four PNs and configured as shown in FIG. 5, each side of the 10G link may be one unit of device 200, i.e. the P10G port of the device 200 and 201 are linked and the GP ports on each device are not trunked. The PN identifies the unique flow path from one GP port on one side (on device 200) to another GP port on the other side (on device 201). For example, the flow paths and their corresponding ports are as follows:

| PN | Egress | Egress | Ingress | Ingress | |
|---|---|---|---|---|---|
| number | source | destination | source | destination | Ingress |
| PN0 | GP0 205 | GPB0 206 | GPB0 206 | GP0 205 | 425 |
| PN1 | GP1 210 | GPB1 211 | GPB1 211 | GP1 210 | 430 |
| PN2 | GP2 215 | GPB2 216 | GPB2 216 | GP2 215 | 435 |
| PN3 | GP3 220 | GPB3 221 | GPB3 221 | GP3 220 | 440 |

For devices connected to GP ports (i.e. GP0-3, 205, 210, 215 and 220, and GPB0-3, 206, 211, 216 and 221), the E-chips 200 and 201, and the P10G link are transparent. The connection between GP0 205 to GPB0 206 appears to be direct physical connection with no intervening devices. There is no switching necessary in between the GP ports. As illustrated in FIG. 5 using broken lines, the flow path identified by PN0 acts exactly as a physical conduit between GPB0 206 and GP0 205 with no intervening devices, except that the segment 425 makes the long distance link between GP0 205 and GPB0 206 possible.

When the E-chip is operating with four untrunked GP ports and four unique PNs, the RX_BUF 400 is segregated into four segments, one dedicated segment for each PN, i.e. flow path. As shown in FIG. 5, segments 425, 430, 435 and 440 are for PN0, PN1, PN2 and PN3 respectively. At least one segment is assigned to each PN. When a PN has multiple VCs, multiple segments may be assigned to the PN or the VCs may share the same segment. It is also possible and desirable in some situations that some VCs share one segment while other VCs each have their own segment. Since each untrunked GP port can operate independently, each of them can be configured independently with respect to the type of ports (e.g. F-port, E-port etc.), speed of transmission (1, 2, or 3 Gbps etc.), type of segments etc.

The links and the PNs may be setup and configured during the initial network setup, i.e. when the components for the Fibre Channel network, including the optical fibre, nodes and switching devices are connected. Once the PNs are configured and assigned, they are fixed until the next time the involved portion of the Fibre Channel network is reconfigured. With fixed PNs, frames identified with PNs and VCs will be transmitted, received into dedicated segments and assigned to GP ports. There is no switching taking place within the E-chips, e.g. devices 200 and 201, utilizing the PN. This eliminates the unnecessary complexity in intermediate devices or switches, such as the E-chip.

With PNs, many different configurations can be setup using the same “switches”, e.g. E-chips. In the 10G mode, besides the two configurations described above, e.g. 4-trunked GP ports and no trunked GP ports, there are many other configurations that can be setup for different applications. In some embodiments, the 10G port on an E-chip is connected to a 10G port on a node device and the connection is operating in a 10G mode. In a preferred embodiment operating in the 10G mode, there are typically two E-chips with their 10G ports linked together. The configuration of GP ports may be identical. It is essentially setup by one E-chip during the initial configuration for the two E-chip link. For example, the GP ports on an E-chip may be configured as 2 trunked GP ports running at 1 Gbps and 2 trunked GP ports running at 3 Gbps. In this case, there are two paths: PN0 for the first pair of trunked GP ports and PN1 for the second pair of GP ports. Each path may be assigned two segments. A total of four segments are assigned to the two PNs.

In another configuration, the first 2 GP ports may be trunked and running 1 Gbps each. The third and fourth GP ports may be untrunked and running at 2 Gbps each. The transmission speeds may be dictated by other conditions or components beyond the two E-chips.

Each flow path is identified by a PN. If there are less flow paths in a particular application, i.e. Fibre Channel network, then some PNs will be left unused. A chip, e.g. an E-chip, can only support a number of paths that does not exceed the available number of PN. For each PN, one or more dedicated segments are assigned. The number of segments on a chip may also be limited. When there are additional PNs available but not additional segments, the additional PN may be left un-used or the PN may share a segment with another PN. It is possible for multiple PNs to share a segment. When more than one PN is sharing a segment, the communication in one PN could potentially be blocked by the other PNs sharing the segment. It is desirable to have at least one segment dedicated to each PN. Thus, it is desirable to have the number of segments in a chip be equal to or greater than the number of PNs. In the embodiments shown in FIG. 4 and 5, the number of PNs and the number of segments are the same. Both are four (4).

VCs are used in many Fibre Channel switches for the inter-switch links. As indicated above, when PN mechanism is used in the 10G mode, the E-chips are “non-switching” switches. E-chips having PNs do not assign VCs for the 10G link between themselves. But E-chips will maintain all VCs assigned by other switches within the Fibre Channel network as part of the frames they are transmitting without any alteration, e.g. the VCs assigned by a GP port on an E-chip for the interswitch link between the GP port and another port on another switch. VCs and PNs may be used by different parts of the Fibre Channel network and co-exist without interference with each other.

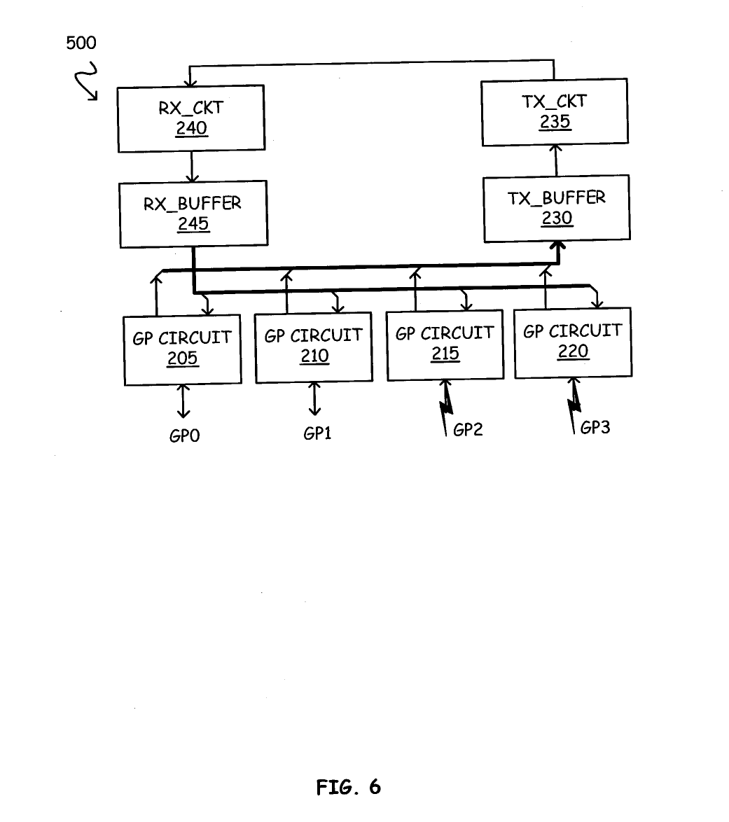

Referring to FIG. 6, device 500 is configured to operate in a long haul mode. In a long haul mode of operation, only GP ports are used. In a long haul mode, longer distances are possible even with the same number of buffers for each flow path when running at lower speed. The reason is that with N buffer credits, the time to transfer N frames at lower speed is longer; thus a longer time can be allowed to return credits to the transmitting device before the N credits are exhausted. A longer time means the link round trip delay (and corresponding distance) can be longer. In the example shown in FIG. 6, two GP ports (e.g. GP0 205 and GP1 210), which are called internal GP ports, are connected to internal devices (i.e. with short link distance) and two GP ports, which are called external GP ports, are connected to external devices (i.e. with very long link distance from the GP port to those devices, e.g. GP2 210 and GP3 215.) The Egress direction refers to the frame flow direction from the internal GP ports, i.e. GP0 and GP1, to external GP ports, i.e. GP2 and GP3. The Ingress direction refers to the frame flow direction from the external GP ports to the internal GP ports. In the long haul mode, a PN is associated with a unidirectional flow path, rather than a bidirectional flow path as in the 10G mode. As an example, in the long haul mode, for a frame traveling from an internal device connected to GP0 205 to an external device connected to GP2 215, it flows through an internal GP port GP0 205, to the TX_BUF 230, to TX_CKT 235, makes a U-turn to RX_CKT in the same device 500, to RX_BUF 245, then to external GP port

Even though the frames flow in a single direction, i.e. from the internal device to the external device, inside the device 500, the frames flow through in “two” directions, i.e. leaving a GP port and returning to a (although a different) GP port. Therefore, in a long haul mode, one PN can identify only one unidirectional flow path. For the flow path between a source and a destination, there is one PN. When the source and the destination reverse, another PN is used in long haul mode.

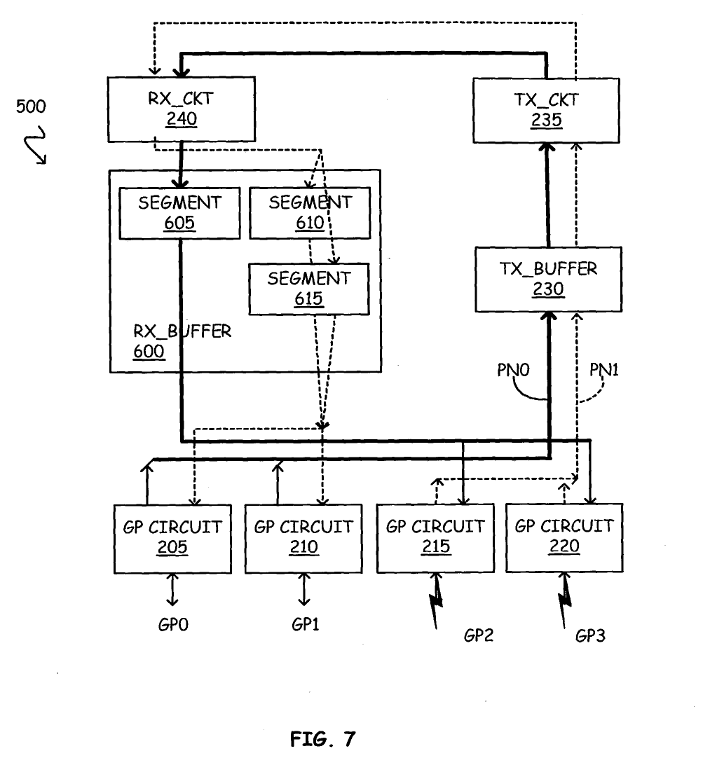

FIG. 7 shows more detail of one configuration in the long haul mode. In FIG. 7, internal GP ports GP0 205 and GP1 210 are trunked together, and the external GP ports GP2 210 and GP3 215 are trunked together. There is only one bidirectional frame flow, or two unidirectional flow paths. Two PNs are used: PN0 is for the egress flow path shown in solid lines and PN1 is for the ingress flow path shown in broken lines. The RX_BUF 600 is segregated into three segments, one small, segment 605 for the egress direction and two (one large segment 610 and one small segment 615) for the ingress direction. If there are more segments available, then PN1 can be allocated with more segments, especially buffered segments to be used by other VCs.

Although two pairs of two trunked GP ports are appropriate for many applications running in long haul mode, there can be many other configurations of combined trunked and untrunked GP ports for various applications. For example, three GP ports on one side may be trunked and there is an untrunked GP port on the other side. The three trunked ports may each running at 1 Gbps for a trunked transmission rate of 3 Gbps. The untrunked GP port runs at 2 Gbps to mate with the three trunked ports. In another example, two GP ports on one side may be trunked and one GP port on the other side untrunked. The last GP port is unused. The two trunked GP ports may be running at 1 Gbps for a total of 2 Gbps transmission rate. The trunked ports mate with the connected untrunked GP port running at 2 Gbps. These unbalanced configurations can be very useful when connecting existing Fibre Channel network portions with newly constructed ports. The existing network fibers may only be capable of supporting slower transmission rates while the new fibers may be capable of supporting higher transmission rates. It may be necessary to use the trunking to bridge the transmission speed differences. In each of the above configurations, there is only one bidirectional flow path, or two unidirectional paths. Either the trunked ports or the single untrunked port may be the internal port or external port. The assignment of PNs and segments are the same as with the example shown in FIG. 7.

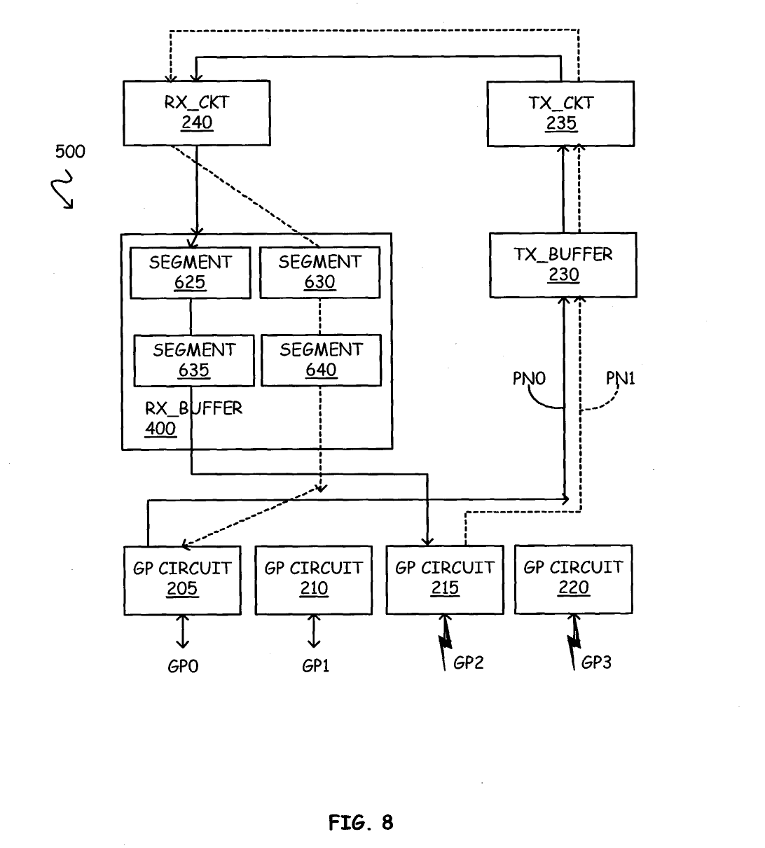

FIG. 8 illustrates another configuration of the operation in the long haul mode. In FIG. 8, the GP ports are not trunked. There are two independent bidirectional flow paths, one is from internal GP port GP0 205 to external GP port 215; another is from internal GP port 210 to external GP port 220. The PN assignment may be as follows.

| PN | Egress | Egress | Ingress | Ingress |
|---|---|---|---|---|
| number | source | destination | source | destination |
| PN0 | GP0 205 | GP2 215 | | |
| PN1 | | | GP2 215 | GP0 205 |
| PN2 | GP1 210 | GP3 220 | | |
| PN3 | | | GP3 220 | GP1 210 |

For a typical non-trunked long haul operation as shown in FIG. 8, the non-trunked GP ports may be F ports. Each of the two bidirectional paths uses one segment for all ingress frames and one segment for all egress frames, for a total of four segments. For clarity, only two flow paths and their PNs are shown in FIG. 8. Flow path identified by PN0 is shown in solid lines, from GP0 205, to 230, 235, 240, 625 and GP2 215. Flow path identified by PN1 is shown in broken lines, from GP2 215, to 230, 240, 630 and GP0 205.

For a typical non-trunked E-port long haul operation, similar to the configuration as shown in FIG. 8, at least three segments are desirable per bidirectional flow path, i.e. one segment for the egress flow path, and at least two segments for the ingress flow path.

In some devices where the current invention is implemented, only four segments are available in one device, so if three or more segments are desired per bidirectional flow path, only one pair of non-trunked GP ports, acting as E ports, can operate. In this embodiment, one PN is assigned for each unidirectional flow path. So out of the four available PNs, only two PNs are used and two PNs are not used. Out of the four available GP ports, only two are used and two are left unused. In the example as described above, E-chip with only four GP ports, four PNs and four segments, there can be only one bidirectional flow path in the long haul mode if the ports are E-ports and no segment is shared by different PNs.

In other embodiments, when at least six segments are available in one device, then two pairs of non-trunked GP port, acting as E ports can both operate where no segment is shared by different PNs. The PN, GP port and segment assignments may be the following:

| PN | Egress | Egress | Ingress | Ingress |
|---|---|---|---|---|
| number | source | destination | source | destination |
| PN0 | GP0 205 | GP2 215 | | |
| PN1 | | | GP2 215 | GP0 205 |
| PN1 | | | GP2 215 | GP0 205 |
| PN2 | GP1 210 | GP3 220 | | |
| PN3 | | | GP3 220 | GP1 210 |
| PN3 | | | GP3 220 | GP1 210 |

The configurations may be different if segments are shared.

It will be recognized by one of ordinary skill in the art that a device in accordance with the invention may include more or fewer than four Fibre Channel port circuits, any number of segments, and, perhaps, more than one high-speed circuit such as port circuit 225. It is also possible that there is no high-speed circuit such as port circuit 225 or all of the ports have high-speed port circuits. A device used in a long haul mode typically does not need a higher speed port, such as the 10G port. It will also be recognized by those of ordinary skill in the art that while port circuit 225 has been described in terms of an IEEE compliant XAUI interface, it may be virtually any interface such as XGMII. Similarly, it will be recognized that any device such as device 200 may utilize special registers (e.g., “global registers”) to identify certain operational characteristics of the components therein. For example, there may be registers to indicate the path number for each GP port acting as a data frame source (egress operations) and additional registers to identify the path number for each GP port acting as a data frame destination (ingress operations).

Various changes in the illustrated embodiments are possible without departing from the scope of the claims. For example, devices in accordance with any of FIGS. 2 through 8 may be implemented in a number of ways including, but not limited to, Application Specific Integrated Circuits (ASICs), Field Programmable Gate Arrays (FPGAs), one or more operatively coupled microcontrollers or microprocessors and discrete logic, or a combination of one or more of these technologies. In addition, buffer circuits in accordance with 230, 245, 400 and 600 may be implemented using any convenient storage technology including, but not limited to single or multiple random access memories (RAMs) with single or separate control circuitry. Storage devices suitable for tangibly embodying program instructions include all forms of non-volatile memory including, but not limited to: semiconductor memory devices such as Electrically Programmable Read Only Memory (EPROM), Electrically Erasable Programmable Read Only Memory (EEPROM), and flash devices.

The current invention described above is mainly associated with a particular Fibre Channel device, an E-chip where there are only two kinds of Fibre Channel ports, P10G and GP ports available. This is for simplicity of describing the invention only, not to limit the applicability of the current invention. The current invention may also be implemented in many other devices or chips, whether there is one type of Fibre Channel ports available or many different types of Fibre Channel ports available.

Thus, while the invention has been disclosed with respect to a limited number of embodiments, numerous modifications and variations will be appreciated by those skilled in the art. It is intended, therefore, that the following claims cover all such modifications and variations that may fall within the true sprit and scope of the invention.

What is claimed is:

1. A method for providing flexibility in configuring a Fibre Channel device in a network, the device having a plurality of Fibre Channel ports, a buffer memory, and a flow control module,
the method comprising:
assigning an identifier for a flow path associated with a first logical port on the device and a second logical port on the device and wherein frames flow from the first logical port to the second logical port;
receiving a frame in the flow path based on the identifier; and
transmitting a frame in the flow path based on the identifier.

2. The method as in claim 1, wherein within the flow path, frames flow from the second logical port to the first logical port.

3. The method as in claim 1, further comprising:
assigning a second identifier for a second flow path, the second flow path associated with the first logical port and the second logical port on the device, and wherein frames flow from the second logical port to the first logical port.

4. The method as in claim 1,
wherein the first logical port is a physical Fibre Channel port.

5. The method as in claim 1,
wherein the first logical port is a group of trunked physical Fibre Channel ports.

6. The method as in claim 1,
wherein the first logical port is one of a plurality of logical ports that share one physical Fibre Channel port.

7. The method as in claim 1,
wherein the second logical port is a physical Fibre Channel port.

8. The method as in claim 7,
wherein the first logical port is a group of trunked physical Fibre Channel ports; and
wherein each port in the group of trunked physical Fibre Channel ports is slower than the physical Fibre Channel port that constitutes the second logical port.

9. The method as in claim 1,
wherein the second logical port is a group of trunked physical Fibre Channel ports.

10. The method as in claim 1,
wherein the second logical port is one of a plurality of logical ports that share one physical Fibre Channel port.

11. The method as in claim 1, further comprising:
allocating one or more parts of the buffer memory to the flow path identified by the identifier.

12. The method as in claim 11, wherein the first logical port includes a plurality of virtual channels;
wherein one or more virtual channels are associated with the flow path, and
wherein one or more virtual channels are assigned to one part of the buffer memory.

13. The method as in claim 1, further comprising:
setting the identifier for the flow path at the initial ports connection configuration.

14. The method as in claim 13, wherein the identifier for the flow path does not change, unless a port associated with the flow path is taken off-line.

15. A device for Fibre Channel network, comprising:
a plurality of logical ports;
circuitry connecting the plurality of logical ports, the circuitry including at least one flow path between two of logical ports; and
a control module coupled to the plurality of logical ports and the circuitry,
wherein the control module is operable to assign an identifier for a flow path, in the circuitry wherein the control module is operable to receive frames into and transmit frames out of the flow path identified by the identifier and wherein the circuitry transfers frames in the flow path identified by the identifier.

16. The device in claim 15, wherein the plurality of logical ports include a first logical port and a second logical port, wherein the flow path is associated with the first logical port and the second logical port, and wherein frames flow from the first logical port to the second logical port.

17. The device in claim 16, wherein frames flow from the second logical port to the first logical port.

18. The device in claim 15, wherein the control module is operable to assign a second identifier for a second flow path,
wherein the second flow path is associated with the first logical port and the second logical port, and
wherein frames flow from the second logical port to the first logical port.

19. The device in claim 15, wherein one of the plurality of logical ports is selected from a group consisting of:
a physical port,
a group of trunked physical ports, and
a part of a physical port which is shared by a plurality of logical ports.

20. The device in claim 15, wherein the control module is operable to assign the identifier for the flow path at the initial ports connection configuration.

21. A Fibre Channel switch, comprising:
a plurality of logical ports;
circuitry connecting the plurality of logical ports, the circuitry including a buffer memory coupled to the plurality of logical ports and at least one flow path between two logical ports; and
a control module coupled to the plurality of logical ports and the circuitry,
where the control module is operable to assign an identifier for a flow path in the circuitry, wherein the control module is operable to receive frames into and transmit frames out of the flow path identified by the identifier and wherein the circuitry transfers frames in the flow path identified by the identifier.

22. The switch in claim 21, wherein the plurality of logical ports include a first logical port and a second logical port, wherein the flow path is associated with the first logical port and the second logical port, and wherein frames flow from the first logical port to the second logical port.

23. The switch in claim 22, wherein frames flow from the second logical port to the first logical port.

24. The switch in claim 21, wherein the control module is operable to assign a second identifier for a second flow path,
wherein the second flow path is associated with the first logical port and the second logical port, and
wherein frames flow from the second logical port to the first logical port.

25. The switch in claim 22, wherein one of the plurality of logical ports is selected from a group of:
a physical port,
a group of trunked physical ports, and
a part of a physical port which is shared by a plurality of logical ports.

26. The switch in claim 21, wherein the control module is operable to allocate a part of the buffer memory to the flow path identified by the identifier.

27. The switch in claim 26, wherein the first logical port includes a plurality of virtual channels and wherein the control module is further operable to divide the part of buffer memory allocated to the flow path into segments of various sizes where each segment is either dedicated to a virtual channel within the flow path, or shared by multiple virtual channels within the flow path.

28. A Fibre Channel network comprising:
a first switch having:
at least one fast port;
a plurality of slow ports;
circuitry connecting all of the ports, the circuitry including a first buffer memory and at least one flow path between all of the ports; and
a first control module coupled to all the ports and the circuitry; a second switch having:
at least one fast port;
a plurality of slow ports;
circuitry connecting all of the ports, the circuitry including a second buffer memory and at least one flow path between all of the ports; and
a second control module coupled to all the ports and the circuitry; and
a link connecting the first ports of the first and second switches;
wherein the first control module is operable to assign an identifier to a flow path which passes through the fast port link, and
wherein the second control module is operable to accept the assigned identifier for the flow path by the first control module.

29. The Fibre Channel network as in claim 28,
wherein the second control module is operable to allocate a part of the second buffer memory to the flow path.

30. The Fibre Channel network as in claim 29,
wherein the flow path is from a slow port to the first fast port on the first switch, passing through the fast port link, to the second fast port to a slow port on the second switch,
wherein frames flow from the slow port on the first switch to the slow port on the second switch forward and backward.

31. The Fibre Channel network as in claim 29,
wherein the flow path is from a group of trunked slow ports to the first fast port on the first switch, passing through the fast port link, to the second fast port to a group of trunked slow ports on the second switch,
wherein frames flow from the group of trunked slow ports on the first switch to the group of trunked slow ports on the second switch, forward and backward.

32. The Fibre Channel network as in claim 29,
wherein the first control module is operable to assign the identifier to the flow path at the initial port connection and configuration.

33. A Fibre Channel network, comprising:
a first device having:
one or more logical ports, including a first logical port;
a second switch having:
a plurality of logical ports, including a second logical port and a third logical port, wherein the second switch is connected to the first device;
circuitry connecting the plurality of logical ports, the circuitry including a buffer memory and at least one flow path between two logical ports; and
a control module coupled to all the logical ports and the buffer memory; and
a third device having:
one or more logical ports, including a fourth logical port, wherein the third device is connected to the second switch;
wherein the control module is operable to assign a first identifier to a flow path which passes through the second switch.

34. The Fibre Channel network as in claim 33,
wherein the first device and the second switch are connected through the first logical port and the second logical port;
wherein the third device and the second switch are connected through the fourth logical port and the third logical port;
wherein within the flow path, frames flow from the second logical port to the third logical port.

35. The Fibre Channel network as in claim 34, wherein the control module is operable to assign a second identifier to a second flow path which passes through the second switch between the second logical port and the third logical port,
wherein within the second flow path, frames flow from the third logical port to the second logical port.

36. The Fibre Channel network as in claim 33,
wherein the control module is operable to assign a part of the buffer memory to the flow path.

37. The Fibre Channel network as in claim 33, wherein the first device is a device selected from the group consisting of:
a switch, a storage device and a host.

38. The Fibre Channel network as in claim 33, wherein the third device is a device selected from the group consisting of:
a switch, a storage device and a host.

39. The Fibre Channel network as in claim 33, wherein each logical port is a port selected from the group consisting of:
a physical port,
a group of trunked physical ports, and
a part of a physical port which are shared by a plurality of logical ports.

40. The Fibre Channel network as in claim 39,
wherein the second logical port and the third logical ports are groups of trunked physical ports, and
wherein the frames in the flow path flow from the second logical port to the third logical port.

41. The Fibre Channel network as in claim 40, wherein the control module is operable to assign a second identifier to a second flow path which passes through the second switch between the second logical port and the third logical port and wherein within the second flow path, frames flow from the third logical port to the second logical port.

42. The Fibre Channel network as in claim 41,
wherein the control module is operable to assign a part of the buffer memory to the second flow path.

43. The Fibre Channel network as in claim 33, wherein the second switch and third device are connected by a link, the second switch and the first device are connected by a link, and the length of the link between the second switch and the third device is longer than the length of the link between the second switch and the first device.

44. The Fibre Channel network as in claim 33,
wherein the first device further comprises a fifth logical port;
wherein the second switch further comprises sixth and seventh logical ports;
wherein the third device further comprises an eighth logical port;
wherein the fifth logical port connects to the sixth logical port;
wherein the seventh logical port connects to the eighth logical port; and
wherein the control module is operable to assign a second identifier to a flow path which passes through the second switch between the sixth logical port and the seventh logical port.

45. A Fibre Channel network system comprising: a first switch having:
a plurality of logical ports, including a first logical port;
first circuitry connecting the plurality of logical ports, the circuitry including a first buffer memory and at least one flow path between two logical ports; and
a first control module coupled to the plurality of logical ports and the circuitry, a second switch having:
a plurality of logical ports, including a second logical port and a third logical port, wherein the second logical port is connected to the first logical port on the first switch by a link;
second circuitry connecting the plurality of logical ports, the circuitry including a second buffer memory and a plurality of flow paths between the plurality of logical ports; and
a second control module coupled to the logical ports and the second circuitry;
a third device having a plurality of logical ports; and
a fourth device having a plurality of logical ports;
wherein the first control module is operable to assign an identifier to a flow path which passes through the link between the first logical port and the second logical port, and
wherein the second control module is operable to accept the assigned identifier for the flow path given by the first control module,
wherein the third device is connected to the first switch, and
wherein the fourth device is connected to the second switch.

46. The Fibre Channel network system as in claim 45,
wherein each logical port is selected from the group consisting of
a physical port,
a group of trunked physical ports, and
a part of a physical port which are shared by a plurality of logical ports.

47. The Fibre Channel network system as in claim 46,
wherein for the connection between the third device and the first switch, the logical ports are untrunked physical ports; and
wherein for the connection between the fourth device and the second switch, the logical ports are untrunked physical ports.

48. The Fibre Channel network system as in claim 46,
wherein for the connection between the third device and the first switch, the logical ports are groups of trunked physical ports.; and
wherein for the connection between the fourth device and the second switch, the logical ports are groups of trunked physical ports.

49. The Fibre Channel network system as in claim 45, wherein the third device is a device selected from a group consisting of a switch, a host and a storage device.

50. The Fibre Channel network system as in claim 45, wherein the fourth device is a device selected from a group consisting of a switch, a host and a storage device.

51. The Fibre Channel network system as in claim 45,
wherein the second control module is operable to allocate a part of the second buffer memory to the flow path.

52. The Fibre Channel network system as in claim 51,
wherein the flow path is from the third device, to the first switch, to the second switch and to the fourth device, and
wherein frames flow from the third device, to the first switch, to the second switch and to the fourth device, forward and backward.

53. The Fibre Channel network system as in claim 52,
wherein the first and second logical ports connecting the first and second switches are untrunked physical ports;
wherein the logical ports connecting the third device and the first switch are trunked physical ports; and
wherein the logical ports connecting the fourth device and the second switch are trunked physical ports.

54. The Fibre Channel network system as in claim 53,
wherein the first control module is operable to assign the identifier to the flow path at the initial port connection and configuration.
